(19) United States
(12) Patent Application Publication
(10) Pub. No.: US 2011/0159385 A1
(43) Pub. Date: Jun. 30, 2011

(54) HYDROGEN GENERATOR AND FUEL CELL SYSTEM INCLUDING THE SAME

(76) Inventors: Atsushi Tanaka, Osaka (JP); Takeshi Miki, Osaka (JP); Toshihiro Nakai, Osaka (JP); Yoshihiro Todaka, Osaka (JP)

(21) Appl. No.: 13/061,301

(22) PCT Filed: Aug. 31, 2009
(86) PCT No.: PCT/JP2009/065187

§ 371 Date: Feb. 28, 2011

(30) Foreign Application Priority Data
Sep. 2, 2008 (JP) 2008-224910
Sep. 2, 2008 (JP) 2008-224912

(51) Int. Cl. H01M 8/06; B01J 7/00; G05D 7/00

(52) U.S. Cl. 429/416; 422/162; 422/111

(57) ABSTRACT

The present invention provides a hydrogen generator capable of estimating the remaining amount of hydrogen without adding a detection means, which leads to an increase in the cost, and a fuel cell system including the hydrogen generator. The hydrogen generator includes the following: a hydrogen generating portion (3) that holds a hydrogen generating material (4) that reacts with water (2) to generate hydrogen; a water supply means (5) that supplies the water (2) to the hydrogen generating portion (3); a water supply control means (11) that controls the water supply means (5) so as to adjust the amount of the water (2) to be supplied to the hydrogen generating portion (3); and a remaining amount management means (13) that estimates a remaining amount of hydrogen that can be generated in the hydrogen generating portion (3) from water quantity information of the water (2) supplied to the hydrogen generating portion (3), the water quantity information being obtained from the water supply means (5) or the water supply control means (11).

### TECHNICAL FIELD

The present invention relates to a hydrogen generator including a hydrogen generating portion that holds a hydrogen generating material and a water supply means that supplies water to the hydrogen generating portion to generate hydrogen, and a fuel cell system including the hydrogen generator. In particular, the present invention relates to a hydrogen generator capable of estimating a remaining amount of hydrogen that can be generated by the hydrogen generator, and a fuel cell system including the hydrogen generator.

### BACKGROUND ART

With the recent widespread use of mobile equipment such as a notebook computer or a portable telephone, batteries used as a power source of the mobile equipment are increasingly required to have a smaller size and a higher capacity. To meet such demands for a high energy density, small size, and large output capacity of the batteries, fuel cells such as a polymer electrolyte fuel cell are being developed.

The fuel cells can be used continuously as long as a fuel and oxygen are supplied. For example, a polymer electrolyte membrane fuel cell (PEMFC) uses a solid polymer electrolyte as an electrolyte, oxygen in the air as a positive active material, and a fuel (hydrogen, methanol, etc.) as a negative active material, and has attracted considerable attention because it can be expected to have a higher energy density than a lithium ion secondary battery that is in the mainstream at present. In the case of using hydrogen as a fuel for the PEMFC, a method has been proposed that generates hydrogen by a reaction of water and a hydrogen generating material including metals with high ionization tendency such as lithium, potassium, calcium, sodium, magnesium, and aluminum.

In this method, water is supplied to a hydrogen generating portion that holds the hydrogen generating material, and then the water and the hydrogen generating material react to generate hydrogen as a fuel for the fuel cell. Regarding the above method, Patent Document 1 discloses a technology for generating hydrogen easily at a low temperature by defining the particle size of a metal material used as the hydrogen generating material. Moreover, Patent Document 2 discloses a technology for maintaining the hydrogen generation reaction stably by controlling the water supply to maintain the internal temperature of a container at which the exothermic reaction can continue.

For a hydrogen-fueled automobile that utilizes electric power obtained by using hydrogen that is stored in a hydrogen-storing alloy directly or as a fuel for the fuel cell, Patent Document 3 discloses a method in which the amount of hydrogen fed by a hydrogen forced feeder and the pressure of a hydrogen storage tank are measured with a flowmeter and a manometer, and the volume of the hydrogen supplied from the hydrogen-storing alloy is calculated, thereby determining a residual hydrogen amount.

### PRIOR ART DOCUMENTS

### Patent Documents

Patent Document 1: JP2006-306700 A

Patent Document 2: JP 2007-45646 A

Patent Document 3: JP H10 (1998)-252567 A

### DISCLOSURE OF INVENTION

### Problem to be Solved by the Invention

In mobile equipment such as a notebook computer or a portable telephone using a fuel cell, it is necessary to know a remaining battery level that indicates the available time of the equipment. When the fuel cell uses hydrogen as a fuel, the remaining battery level significantly depends on the remaining amount of hydrogen that is to be supplied to the fuel cell.

However, in the above method for generating hydrogen by a reaction of water and the hydrogen generating material, unlike the method using hydrogen that is stored in the hydrogen-storing alloy or the like, it is difficult to directly know the total amount of hydrogen to be supplied. Moreover, in the conventional method for measuring the amount of hydrogen to be supplied, devices such as a flowmeter and a manometer are required. This is not suitable for the fuel cell used in the mobile equipment that should be small and lightweight, and also increases the cost. Further, in the method for measuring the amount of current generated by the fuel cell, a current detector is required. If the fuel cell cannot use all of the generated hydrogen to produce electric power, and some hydrogen is released to the outside, there may be an error in the remaining amount.

With the foregoing in mind, it is an object of the present invention to provide a hydrogen generator capable of estimating a remaining amount of hydrogen without adding a detection means, which leads to an increase in the cost, and a fuel cell system including the hydrogen generator.

### Means for Solving Problem

To solve the above problem, a hydrogen generator of the present invention includes the following: a hydrogen generating portion that holds a hydrogen generating material that reacts with water to generate hydrogen; a water supply means that supplies the water to the hydrogen generating portion; a water supply control means that controls the water supply means so as to adjust the amount of the water to be supplied to the hydrogen generating portion; and a remaining amount management means that estimates a remaining amount of hydrogen that can be generated in the hydrogen generating portion from water quantity information of the water supplied to the hydrogen generating portion, the water quantity information being obtained from the water supply means or the water supply control means.

A fuel cell system of the present invention includes the hydrogen generator of the present invention and a fuel cell that produces electric power using the hydrogen generated by the hydrogen generator.

### Effects of the Invention

The hydrogen generator of the present invention generates hydrogen by a reaction of the water and the hydrogen generating material, and is capable of estimating the remaining amount of hydrogen that can be generated in the hydrogen generating portion without adding a separate means for detecting the amount of hydrogen generated.

For this reason, the fuel cell system of the present invention can make it easy to know the remaining battery level.

### BRIEF DESCRIPTION OF DRAWINGS

FIG. 1 is a block diagram showing a schematic configuration of a hydrogen generator and a fuel cell system including the hydrogen generator according to Embodiment 1 of the present invention.

FIG. 2 is a diagram showing a cumulative amount of water supplied that is calculated by a remaining amount management device of the hydrogen generator according to Embodiment 1 of the present invention. FIG. 2A shows changes in the amount of water supplied per unit time FIG. 2B shows changes in the total amount of water supplied (i.e., the cumulative amount of water supplied).

FIG. 3 is a block diagram showing a schematic configuration of a hydrogen generator and a fuel cell system including the hydrogen generator according to Embodiment 2 of the present invention.

FIG. 4 is a flow chart showing operations of a control portion of the hydrogen generator according to Embodiment 2 of the present invention.

FIG. 5 is a diagram showing the relationship between the amount of water supplied and the amount of hydrogen generated in the hydrogen generator according to Embodiment 2 of the present invention, where the reaction of the hydrogen generating material and the water has not proceeded much.

FIG. 6 is a diagram showing the relationship between the amount of water supplied and the amount of hydrogen generated in the hydrogen generator according to Embodiment 2 of the present invention, where the reaction of the hydrogen generating material and the water has proceeded to a large extent. FIG. 6A shows a state in which a large amount of water is supplied at the beginning of water supply. FIG. 6B shows a state in which a constant amount of water is supplied.

### DESCRIPTION OF THE INVENTION

As described above, the hydrogen generator of the present invention includes a hydrogen generating portion that holds a hydrogen generating material that reacts with water to generate hydrogen, a water supply means that supplies the water to the hydrogen generating portion, a water supply control means that controls the water supply means so as to adjust the amount of the water to be supplied to the hydrogen generating portion, and a remaining amount management means that estimates a remaining amount of hydrogen that can be generated in the hydrogen generating portion from water quantity information of the water supplied to the hydrogen generating portion, the water quantity information being obtained from the water supply means or the water supply control means.

With this configuration, the amount of hydrogen that can be generated by the hydrogen generator is known from the water quantity information of the water supplied to the hydrogen generating portion, which is obtained from the water supply means or the water supply control means. Comparing this amount of hydrogen and the total amount of hydrogen that can be generated from the hydrogen generating material, it is possible to estimate the remaining amount of hydrogen that can be generated from the hydrogen generating material without providing a means for measuring the amount of hydrogen generated from the hydrogen generating material, such as a flowmeter.

It is preferable that the remaining amount management means estimates the remaining amount of hydrogen that can be generated in the hydrogen generating portion from the total amount of the water supplied to the hydrogen generating portion. With this configuration, the amount of hydrogen can be calculated based on the amount of the water used for hydrogen generation.

It is preferable that the remaining amount management means estimates the remaining amount of hydrogen that can be generated in the hydrogen generating portion from an operation time of the water supply means. With this configuration, when the flow rate of the water is constant, the amount of the water supplied to the hydrogen generating portion can be calculated based on one parameter, i.e., the time.

It is preferable that the water supply means is electrically powered, and the remaining amount management means estimates the remaining amount of hydrogen that can be generated in the hydrogen generating portion from a cumulative value of a voltage applied to the water supply means. With this configuration, when the water supply means is an electric pump or the like, the amount of the water supplied to the hydrogen generating portion can be calculated using the electrical information that is easily detected, transmitted, and computed.

It is preferable that an attachable/detachable fuel cartridge holding the hydrogen generating material is provided as the hydrogen generating portion, and the fuel cartridge includes a memory for storing the amount of the water supplied or the remaining amount of hydrogen that can be generated. With this configuration, the memory stores the cumulative amount of the water supplied to the hydrogen generating portion of the fuel cartridge or the remaining amount of hydrogen that can be generated, which is estimated from the cumulative amount of the water supplied. Therefore, even if the cartridge is replaced, it is easy to know the remaining amount of hydrogen that can be generated.

It is preferable that the water supply control means controls the amount of the water to be supplied by the water supply means based on the water quantity information of the water supplied to the hydrogen generating portion. With this configuration, an appropriate amount of water can be supplied to the hydrogen generating portion based on the cumulative amount of the water supplied. Therefore, hydrogen can be generated in accordance with the degree of the reaction of the hydrogen generating material and the water in the hydrogen generating portion. Thus, the fuel cell can quickly start to produce electric power.

The fuel cell system of the present invention includes the above hydrogen generator of the present invention and a fuel cell that produces electric power using the hydrogen generated by the hydrogen generator.

With this configuration, the fuel cell system takes advantage of the features of the hydrogen generator of the present invention, and thus can estimate the remaining amount of hydrogen that can be generated from the hydrogen generating material without adding a new means for detecting the amount of hydrogen. Thus, the fuel cell system can make it easy to know the remaining battery level.

Hereinafter, embodiments of the hydrogen generator and the fuel cell system including the hydrogen generator of the present invention will be described with reference to the drawings.

### Embodiment 1

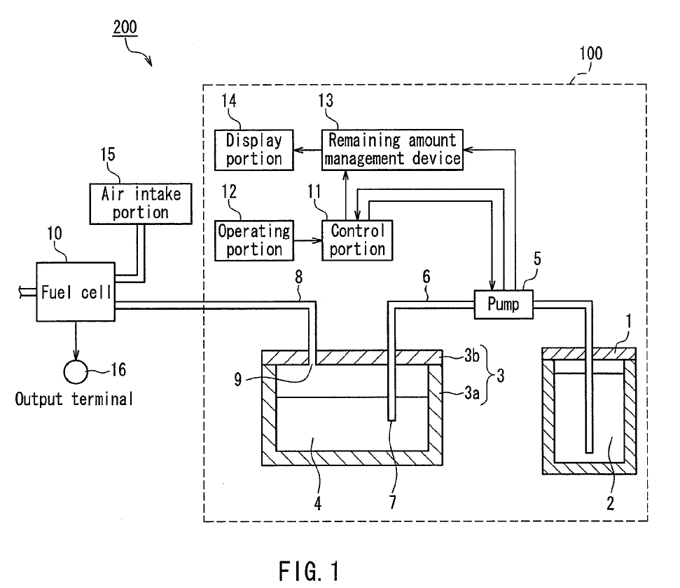

FIG. 1 is a block diagram showing a schematic configuration of a fuel cell system according to Embodiment 1 of the present invention.

As shown in FIG. 1, a fuel cell system 200 of this embodiment includes a hydrogen generator 100 and a fuel cell 10 that produces electric power using the hydrogen generated by the hydrogen generator 100.

The hydrogen generator 100 includes a container 3, a water storage tank 1, and an electric pump 5. The container 3 is a hydrogen generating portion that holds a hydrogen generating material 4 that generates hydrogen by an exothermic reaction with water. The water storage tank 1 contains water 2 that is used to generate hydrogen by the exothermic reaction with the hydrogen generating material 4 in the container 3. The electric pump 5 is a water supply means that supplies the water 2 from the water storage tank 1 to the container 3. The hydrogen generator 100 also includes a control portion 11 and a remaining amount management device 13. The control portion 11 is a water supply control means that operates the pump 5 (water supply means) so as to control the amount of the water 2 to be supplied from the water storage tank 1 to the container 3 (hydrogen generating portion). The remaining amount management device 13 is a remaining amount management means that estimates a remaining amount of hydrogen that can be generated in the hydrogen generating portion from water quantity information of the water 2 supplied to the container 3. The water quantity information is obtained from the control portion 11 or the pump 5 (water supply means). In FIG. 1, the container 3 and the water storage tank 1 are represented by cross-sectional views to show their internal structures.

The container 3 has a container body 3a and a lid 3b. The container 3 is provided with a water inlet pipe 6 and a hydrogen outlet pipe 8. The water inlet pipe 6 penetrates the lid 3b and allows the water 2 contained in the water storage tank 1 to flow into the container body 3a. The hydrogen outlet pipe 8 conducts the generated hydrogen. The water 2 fed from the water storage tank 1 by the pump 5 is supplied to the hydrogen generating material 4 in the container 3 through a water inlet opening 7 of the water inlet pipe 6. The hydrogen generated by the reaction of the hydrogen generating material 4 and the water 2 is conducted from a hydrogen outlet opening 9 through the hydrogen outlet pipe 8 to the fuel cell 10.

The hydrogen generating material 4 in the container 3 is not particularly limited as long as it reacts with water to generate hydrogen. For example, at least one metal material selected from metals with high ionization tendency such as lithium, potassium, calcium, sodium, magnesium, and aluminum, silicon, zinc, and alloys including any of these elements as a main component can be preferably used. In the case of the alloy, there is no particular limitation to the metal composition other than the element serving as the main component. The main component is a material whose content is 80 wt % or more, and more preferably 90 wt % or more of the entire alloy. The above metal material is not likely to react with water at room temperature, but can easily cause the exothermic reaction with water by heating. In this case, the “room temperature” ranges from 20 to 30° C.

The average particle size of the metal material is preferably 0.1 μm to 100 μm, and more preferably 0.1 μm to 50 μm. The shape of the metal material is not particularly limited, and can be a substantial sphere (including a true sphere), a rugby ball, a scale, or the like.

Moreover, the addition of at least one material selected from a hydrophilic oxide, carbon, and a water absorptive polymer to the hydrogen generating material 4 (metal material) is preferred because the reaction of the metal material and water can be accelerated. Examples of the hydrophilic oxide include alumina, silica, titania, magnesia, zirconia, zeolite, and a zinc oxide. Furthermore, the hydrogen generating material 4 preferably includes a heat generating material that reacts with water to generate heat and is a material other than the hydrogen generating material 4, so that the exothermic reaction of the hydrogen generating material 4 and the water 2 starts easily. The heat generating material may be, e.g., a material that reacts with water to form a hydroxide or hydrate, or a material that reacts with water to generate hydrogen. These materials may be used individually or in combinations of two or more.

Although not shown, the water inlet pipe 6 and the hydrogen outlet pipe 8 have removal mechanisms, respectively. With these removal mechanisms, the container 3 can be separated from the hydrogen outlet pipe 8, the fuel cell 10 connected to the end of the hydrogen outlet pipe 8, and the water storage tank 1. When the hydrogen generating material 4 reacts with the water 2 to generate hydrogen in the container 3, the hydrogen generating material 4 in the container 3 changes into a reaction product and loses the ability to generate hydrogen. Therefore, it becomes more difficult to generate hydrogen further with increasing the proportion of the hydrogen generating material 4 that has changed into the reaction product due to the reaction with the water. In such a case, the container 3, in which the reaction rate of the hydrogen generating material 4 is increased, may be removed along with the hydrogen generating material 4 by the removal mechanisms (not shown) and replaced with another container 3 containing a new hydrogen generating material 4. Thus, hydrogen can continue to be generated.

The water 2 in the water storage tank 1 also is reduced by the reaction with the hydrogen generating material 4. Therefore, it is preferable that the water storage tank 1 has the same removal mechanism, and is removed and replaced with another water storage tank 1 containing a required amount of water 2 at the same time as replacing the container 3 with one that contains the new hydrogen generating material 4.

The material and shape of the container 3 are not particularly limited as long as the container 3 can hold the hydrogen generating material 4 that generates hydrogen by the exothermic reaction with the water 2. However, the material and shape of the container 3 are preferably selected to prevent a leakage of the water 2 or hydrogen from the container 3 other than the water inlet opening 7 and the hydrogen outlet opening 9. Specifically, the suitable material for the container is substantially impermeable to water and hydrogen and does not cause any failure of the container even if it is heated at about 100° C. For example, materials such as aluminum, iron, and stainless steel and resins such as polyethylene (PE) and polypropylene (PP) can be used. The container 3 can be in the form of a prism, a cylinder, or the like.

The reaction product obtained by the reaction of the hydrogen generating material 4 and the water 2 usually has a larger volume than the hydrogen generating material 4. Therefore, it is preferable that the container 3 is deformable in accordance with the reaction of the hydrogen generating material 4 and the water 2 to avoid being damaged if a volume expansion of the contents occurs because of the production of the reaction product. In this regard, the resins such as PE and PP are more suitable for the container 3 than the other materials as described above.

Moreover, it is preferable that the hydrogen outlet pipe 8 or the hydrogen outlet opening 9 provided in the lid 3b of the container 3 has a filter to prevent the water 2 and the hydrogen generating material 4 from flowing out of the container 3. The suitable filter transmits gas, but not easily transmit liquid and solid. For example, a porous gas-liquid separation film made of polytetrafluoroethylene (PTFE) or a nonwoven fabric made of polypropylene (PP) can be used.

In the hydrogen generator 100 of this embodiment shown in FIG. 1, the pump attached to the water inlet pipe 6 supplies the water 2 from the water storage tank 1 to the container 3 at a predetermined supply rate for a predetermined supply time based on a control signal from the control portion 11. The pump 5 is a general electric pump and may be, e.g., a micropump such as a tube pump, a diaphragm pump, or a syringe pump. However, the pump 5 is not limited thereto. The specific configuration of the pump 5 is not particularly limited as long as it is a means for controlling both the supply rate and the supply time of the water 2 to the container 3, i.e., for adjusting the amount of water supply in accordance with the control signal of the control portion 11.

The pump 5 may have the function of detecting the amount of the water 2 actually supplied from the water storage tank 1 to the container 3, and the detection information may be fed back to the control portion 11.

The hydrogen generated by the reaction of the hydrogen generating material 4 and the water 2 in the container 3 is conducted from the hydrogen outlet opening 9 through the hydrogen output pipe 8. The hydrogen thus conducted is transferred to the equipment that uses the hydrogen generated by the hydrogen generator 100 of this embodiment, e.g., the fuel cell 10 in FIG. 1.

The container 3 may have a detection means (not shown) for detecting a state of the reaction of the hydrogen generating material 4 and the water 2. The detection means is preferably a temperature sensor, and a known temperature detecting means such as a thermocouple or a thermistor can be used.

In the hydrogen generator 100 of this embodiment, the control portion 11 controls the pump 5 based on the control signal that is input from an operating portion 12 for hydrogen generation, and adjusts the amount of the water 2 to be supplied to the hydrogen generating material 4, i.e., the supply rate and the supply time of the water 2 so that a predetermined amount of hydrogen will be generated.

Because of these functions, the control portion 11 preferably includes a programmable controller (e.g., a microcomputer) or a microprocessor, and also may include an electronic circuit.

The operating portion 12 gives instructions for hydrogen generation to the control portion 11 and also serves as a user interface that receives, e.g., instructions to start the production of electric power in the fuel cell system 200. The operating portion 12 can be a switch or a touch panel. The operating portion 12 may be configured so that a user directly inputs the operating instructions. Alternatively, the switch signals of various devices that use the electric power produced by the fuel cell 10 as a power source may be directly input to the operating portion 12.

The remaining amount management device 13 (remaining amount management means) receives a signal for controlling the operation of the pump 5 (water supply means), which is output from the control portion 11, and a signal for indicating the actual operating conditions of the pump 5, and detects the amount of the water 2 supplied from the water storage tank 1 to the container 3 (hydrogen generating portion). Based on the amount of the water 2 supplied, the remaining amount management device 13 calculates the amount of hydrogen that can be generated by the reaction of the hydrogen generating material 4 and the water 2 in the container 3. Moreover, the remaining amount management device 13 estimates the remaining amount of hydrogen that can be generated in the container 3 (hydrogen generating portion) from the total amount of hydrogen that can be generated from the hydrogen generating material 4 in the container 3 and the amount of hydrogen that can be generated up to this time. Because of these functions, the remaining amount management device 13 preferably includes a programmable controller (e.g., a microcomputer), as is the case with the control portion 11.

The remaining amount of hydrogen estimated by the remaining amount management device 13 is displayed on a display portion 14 and conveyed to a user. The display portion 14 of the hydrogen generator 100 of this embodiment is not limited to a special display terminal such as a liquid crystal display for displaying the remaining amount of hydrogen in the hydrogen generator 100, as shown in FIG. 1. The information of the remaining amount may be displayed on either a display terminal for displaying the power output of the fuel cell 10 or an operating terminal of the portable equipment that uses the fuel cell 10 as a battery.

For a better hydrogen generation reaction of the hydrogen generating material 4 and the water 2, the outer surface of the container body 3a of the container 3 may be covered with a heat insulator, or the container body 3a may be provided with a heater for heating. However, they are not shown in FIG. 1, and their explanations are omitted. As described above, the hydrogen generating material 4 also may include the heat generating material.

Although not shown in FIG. 1, it is more preferable that the hydrogen outlet pipe 8 includes a gas-liquid separator for separating the hydrogen that is drawn out of the container 3 from unreacted water, and further includes a means for returning the water separated by the gas-liquid separator back to the water storage tank 1. When the hydrogen generating material 4 and the water 2 react in the container 3, a mixture of the unreacted water 2 and the hydrogen may come out of the container 3 through the hydrogen outlet pipe 8. In such a case, the gas-liquid separator can separate the mixture that is discharged from the container 3 into water (liquid) and hydrogen (gas), and in addition, the water can be returned to the water storage tank 1. Thus, the substantial amount of water supply can be reduced, thereby reducing the amount of the water 2 contained in the water storage tank 1. Consequently, it is possible to reduce the total volume and weight of the hydrogen generator 100 and to make the hydrogen generator 100 compact.

The fuel cell 10 may be a well-known polymer electrolyte fuel cell that uses hydrogen as a fuel that reacts with oxygen, e.g., a polymer electrolyte membrane fuel cell (PEMFC).

In a specific configuration example of the fuel cell 10, a plurality of cells, each of which includes an electrolyte and a pair of electrodes (positive and negative electrodes) sandwiching the electrolyte, are formed into a stack. The electrolyte is a solid polymer electrolyte. An oxygen gas (positive active material) in the air that enters through an air intake portion 15 is supplied to the positive electrode. On the other hand, the hydrogen (negative active material) generated by the hydrogen generator 100 is supplied to the negative electrode. With this configuration, when the hydrogen ions of the negative active material pass through the electrolyte toward the positive electrode and are bound to the oxygen molecules, the electrons move in an external circuit, so that electric power is produced. The electric power thus produced is output from an output terminal 16 of the fuel cell 10 to the portable equipment or the like. Since the fuel cell 10 has a general configuration, the detailed explanation of the configuration and the representation of a mechanism for producing the electric power are omitted. The configuration of the electrolyte or the like used in the fuel cell 10 is not limited to the above example.

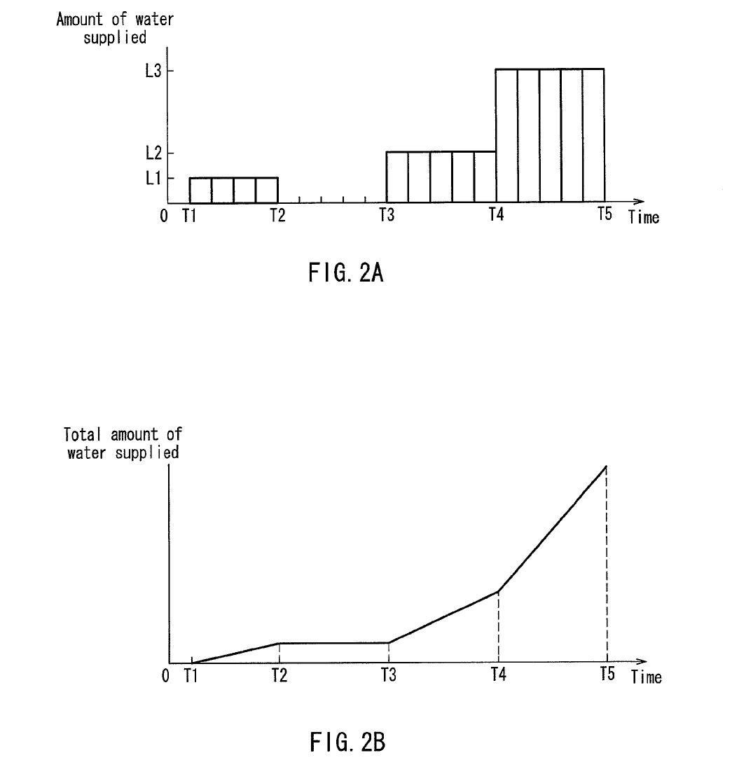

Next, the operation of the hydrogen generator 100 of this embodiment will be described with reference to FIG. 2 as well as FIG. 1. FIG. 2 shows a cumulative amount of the water supplied to the container 3 (hydrogen generating portion) that is calculated by the remaining amount management device 13 of the hydrogen generator 100 of this embodiment.

First, when the operating portion 12 receives, e.g., instructions to start the production of electric power from a user, the control portion 11 feeds power to the pump 5. As a result of the power feeding, the pump 5 starts to supply the water 2 stored in the water storage tank 1 to the container 3 (hydrogen generating portion).

In the container 3, the water 2 supplied through the water inlet pipe 6 by the pump 5 and the hydrogen generating material 4 react to generate hydrogen. The generated hydrogen is supplied to the fuel cell 10 through the hydrogen outlet pipe 8. The fuel cell 10 produces electric power using the hydrogen received from the hydrogen generator 100 and the air (oxygen) taken in from the air intake portion 15.

The control portion 11 controls the pump 5 and thus adjusts the amount of the water 2 to be supplied to the container 3 so that hydrogen can be continuously generated in an amount sufficient for the fuel cell 10 to continue to produce electric power stably. Particularly, if there is no problem in maintaining the amount of water supply constant while the hydrogen is stably generated, the control portion 11 controls the pump 5 to supply a constant amount of water.

The remaining amount management device 13 monitors an indication signal output from the control portion 11 to the pump 5 and simultaneously, or as needed, monitors the operation of the pump 5. Then, the remaining amount management device 13 keeps track of the water quantity information of the water supplied to the container 3 by the pump 5 and calculates the cumulative amount of the water supplied. An example of the information about the amount of the water supplied may be the total amount of the water actually supplied, which is calculated by multiplying the amount of the water supplied per unit time by the supply time.

FIG. 2 shows the relationship between changes in the amount of the water actually supplied and the cumulative total amount of the water supplied. FIG. 2A shows changes in the amount of the water supplied per unit time, i.e., changes in the supply rate. FIG. 2B shows changes in the total amount of the water supplied (i.e., the cumulative amount of the water supplied) with respect to the changes in FIG. 2A.

As shown in FIG. 2A, the water supply starts from a time T1 and continues at a predetermined supply rate of L1 until T2. In this case, as shown in FIG. 2B, the total amount of the water supplied is increased at a constant ratio from T1 to T2. Then, the water supply is stopped between T2 and T3, as shown in FIG. 2A. Accordingly, the total amount of the water supplied remains unchanged, as shown in FIG. 2B.

Subsequently, the water is supplied at a supply rate of L2 from T3 to T4, as shown in FIG. 2A, and the cumulative total amount of the water supplied is increased at a constant ratio again, as shown in FIG. 2B. Moreover, the water is supplied at a higher supply rate of L3 from T4 to T5, as shown in FIG. 2A, and the cumulative total amount of the water supplied is increased to have a larger tilt, as shown in FIG. 2B.

As described above, the remaining amount management device 13 can obtain the water quantity information, i.e., the amount of the water supplied at a predetermined supply rate for a predetermined supply time by multiplying the supply rate by the supply time. By repeating this calculation, the remaining amount management device 13 can determine the cumulative total amount of the water supplied to the container 3. Moreover, the remaining amount (%) of hydrogen that can be generated in the container 3 (hydrogen generating portion) of the hydrogen generator 100 can be obtained by (1−A/B)×100, where A represents the cumulative amount of the water supplied and B represents the amount of the water that is required for all the hydrogen generating material 4 to react to generate hydrogen. The remaining amount of hydrogen is expressed, e.g., as a percentage and displayed on the display portion 14.

As in the case of this embodiment, when the hydrogen generated by the hydrogen generator 100 is used as a fuel for the fuel cell 10, the remaining amount of hydrogen in the hydrogen generator 100 that is calculated by the remaining amount management device 13 directly indicates the remaining battery level of the fuel cell 10.

In the above explanation, the remaining amount management device 13 keeps track of the water quantity information of the water supplied by calculating the cumulative amount of the water actually supplied to the container 3. However, the way of obtaining the water quantity information with the remaining amount management device 13 of this embodiment is not limited to that method.

For example, if the pump 5 supplies the water at a constant supply rate per unit time, or there is no large fluctuation in the supply rate, the water quantity information of the water supplied to the container 3 can be obtained only by managing the operation time of the pump 5. In this case, the parameter that should be managed by the remaining amount management device 13 is the “time” alone. Therefore, compared to the case where two parameters, i.e., the “time” and the “supply rate” need to be managed, the amount of the water supplied can be more easily detected.

In another example, if the pump 5 is an electric pump as described above, and particularly there is a correlation between the magnitude of the voltage applied to the pump 5 and the amount of the water supplied per unit time, the water quantity information can be obtained based on a cumulative value of the voltage applied to the pump 5, which is calculated by multiplying the voltage value by the application time. This method has merit because the parameter that should be managed by the remaining amount management device 13 is the voltage information that can be handled as a numerical value and easily used for an operation or the like.

As described above, in the hydrogen generator 100 of this embodiment, the amount of hydrogen that can be generated by the hydrogen generator can be calculated from the amount of the water supplied without adding a detection means for measuring the amount of hydrogen generated such as a flowmeter that detects the flow rate of hydrogen generated and a manometer that measures the pressure of hydrogen. Moreover, based on the calculated amount of the water supplied, the remaining amount of hydrogen that can be generated by the hydrogen generator 100 can be easily estimated. Further, in the fuel cell system 200 of this embodiment, the remaining battery level of the fuel cell 10 can be determined from the remaining amount of hydrogen that can be generated by the hydrogen generator 100.

Thus, as a small hydrogen generator with high portability and a fuel cell system including the hydrogen generator, this embodiment can be suitably used for a power supply system of various equipment, particularly portable equipment.

### Embodiment 2

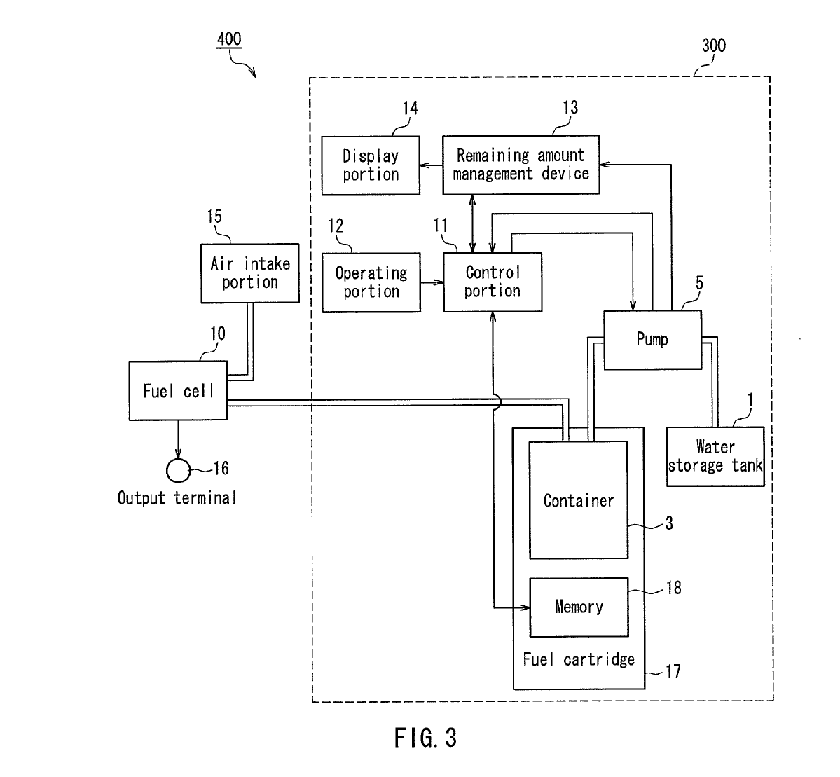

Next, Embodiment 2 of a hydrogen generator and a fuel cell system using the hydrogen generator of the present invention will be described with reference to FIG. 3.

A hydrogen generator 300 of Embodiment 2 differs from the hydrogen generator 100 of Embodiment 1 in that the container 3 (hydrogen generating portion) holding a hydrogen generating material that reacts with water to generate hydrogen is in the form of a fuel cartridge 17 that can be easily attached and detached.

FIG. 3 is a block diagram showing a schematic configuration of a fuel cell system 400 including the hydrogen generator 300 of this embodiment.

The fuel cell system 400 of this embodiment differs from Embodiment 1 in that the fuel cartridge 17 includes the container 3 (hydrogen generating portion) holding the hydrogen generating material and a read/write memory 18 capable of recording the amount of hydrogen that can be generated in the container 3. For the other members of the hydrogen generator 300 having the same configurations as those of the hydrogen generator 100 of Embodiment 1 shown in FIG. 1, such as the water storage tank 1, the electric pump 5 (water supply means), the operating portion 12, and the display portion 14, the detailed explanation will not be repeated. In FIG. 3, the water storage tank 1 and the container 3 are not represented by cross-sectional views, since they also have the same configurations as those of the hydrogen generator 100 of Embodiment 1 shown in FIG. 1.

The container 3 of the hydrogen generator 300 of this embodiment can be easily attached and detached with the fuel cartridge 17. In the hydrogen generator 100 of Embodiment 1, the container 3 can be separated by the removal mechanisms (not shown) of the water inlet pipe 6 and the hydrogen outlet pipe 8. On the other hand, the fuel cartridge 17 of this embodiment is provided under the concept of a unit that a user can frequently and easily replace.

The memory 18 included in the fuel cartridge 17 stores the cumulative amount of the water supplied to the container 3 holding the hydrogen generating material, and is formed of, e.g., an EEPROM (electrically erasable programmable read-only memory). The memory 18 can be of various types into/from which the control portion 11 can properly write/read the cumulative amount of the water supplied. Examples of the memory 18 includes, in addition to the semiconductor memory, a magnetically rewritable magnetic tape medium, a thermally rewritable bar code, and an optically rewritable storage medium using a laser or the like.

In this embodiment, when the control portion 11 receives instructions to start the production of electric power from the operating portion 12, the control portion 11 reads the cumulative amount of the water supplied to the container 3 from the memory 18 in the fuel cartridge 17. Then, the control portion 11 compares the cumulative amount of the water supplied with the information about the amount of the hydrogen generating material in the container 3, and calculates a ratio of the hydrogen generating material that has already reacted with the water to the whole hydrogen generating material. Moreover, the control portion 11 gives the pump 5 (water supply means) a drive signal to supply a predetermined amount of water suitable for the rapid generation of hydrogen to the container 3 in accordance with the calculated amount of the hydrogen generating material that has already reacted with water. Further, the control portion 11 calculates the amount of the water supplied by the pump 5 from the supply rate and the supply time, updates the cumulative amount of the water supplied to the container 3, and writes this into the memory 18.

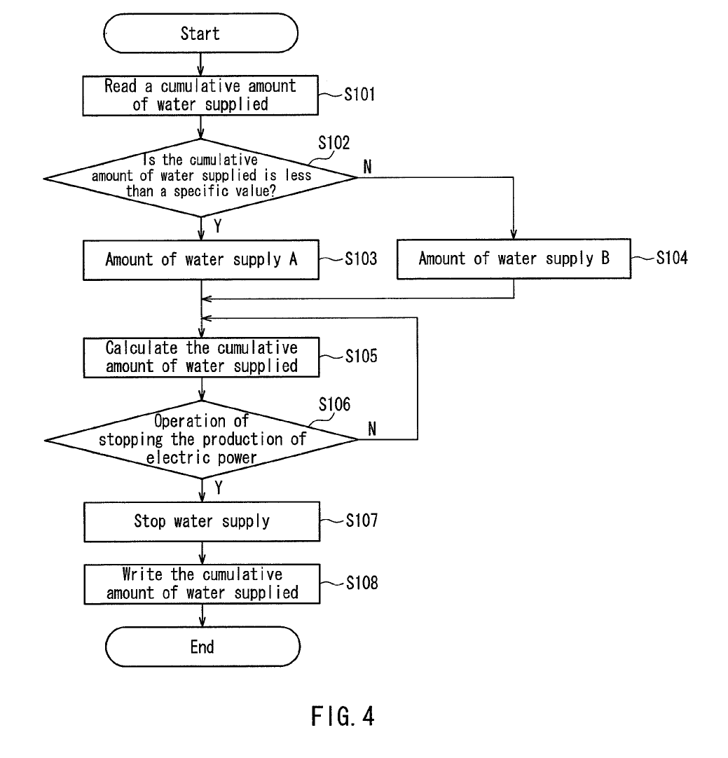

Next, control operations of the amount of water to be supplied to the container 3 in the fuel cell system of this embodiment will be described with reference to FIG. 4.

FIG. 4 is a flow chart showing the operations in the fuel cell system of this embodiment.

In FIG. 4, the amount of water supply A indicates an appropriate amount of water to be supplied when the cumulative amount of the water supplied to the container (hydrogen generating portion) holding the hydrogen generating material is 0 or smaller than a predetermined threshold value. The amount of water supply B indicates an appropriate amount of water to be supplied when the cumulative amount of the water supplied to the container (hydrogen generating portion) holding the hydrogen generating material is large. In general, the start of the hydrogen generation reaction becomes slower as the reaction of the hydrogen generating material and the water proceeds. Therefore, it is preferable that the amount of the water to be supplied to the hydrogen generating material is increased particularly in the early stages of the reaction. Accordingly, in this embodiment, the amount of water supply A being less than the amount of water supply B is established.

The amount of water supply A and the amount of water supply B are numerical values that are determined as needed, e.g., by the materials of the hydrogen generating material, the capacity and shape of the container 3 (hydrogen generating portion), the environmental temperature, the performance of the fuel cell 10, and the electric energy required as the output of the fuel cell 10.

As shown in FIG. 4, the instructions to start the production of electric power are given by manipulating the operating portion 12, and then the operations of the hydrogen generator are started.

In a step S101, the control portion 11, which has received the instructions to start the production of electric power, reads the cumulative amount of the water supplied to the container 3 from the memory 18 in the fuel cartridge 17.

In a step S102, the control portion 11 decides whether or not the cumulative amount of the water supplied is less than a predetermined specific value. The predetermined specific value is defined as a threshold value. If the cumulative amount of the water supplied is not less than the threshold value, the generation of hydrogen is delayed when the hydrogen starts to be produced under the normal conditions of the hydrogen generation reaction.

If the cumulative amount of the water supplied that has been read from the memory 18 is less than the predetermined specific value (i.e., “Yes” in the step S102), the operation proceeds to the next step S103, where the control portion 11 transmits water supply information to the pump 5 so as to supply the amount of water supply A. After the water supply information is transmitted, the pump 5 supplies the amount of water supply A from the water storage tank 1 to the container 3.

On the other hand, if the cumulative amount of the water supplied that has been read from the memory 18 is not less than the predetermined specific value (i.e., “No” in the step S102), the operation proceeds to the next step S104, where the control portion 11 transmits water supply information to the pump 5 so as to supply the amount of water supply B. After the water supply information is transmitted, the pump 5 supplies the amount of water supply B from the water storage tank 1 to the container 3.

Subsequently, in a step S105, the control portion 11 calculates the cumulative amount of the water supplied from the supply rate and the supply time based on the water supply information transmitted to the pump 5.

This operation continues until the operating portion 12 gives instructions to stop the production of electric power (step S106).

When the instructions to stop the production of electric power are given, the control portion 11 stops the pump 5, so that the water supply is stopped (step S107). Then, since the water supply to the container 3 is stopped, the hydrogen generation reaction of the water and the hydrogen generating material in the container 3 is stopped. Consequently, hydrogen is not supplied any longer, and the fuel cell 10 finishes producing electric power.

Thereafter, the control portion 11 writes the latest cumulative amount of the water supplied into the memory 18 (step S108), and a series of the operations is brought to an end.

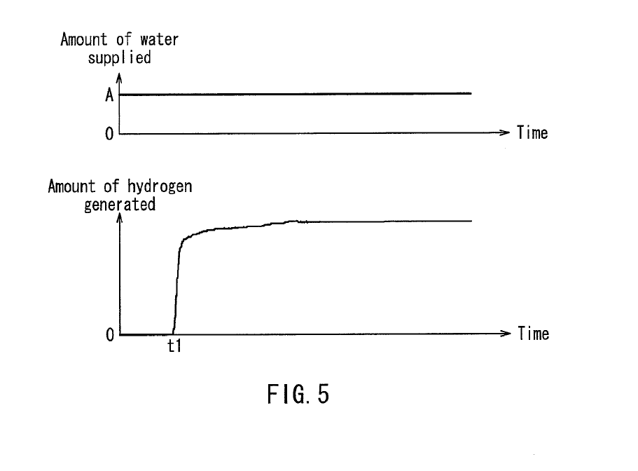

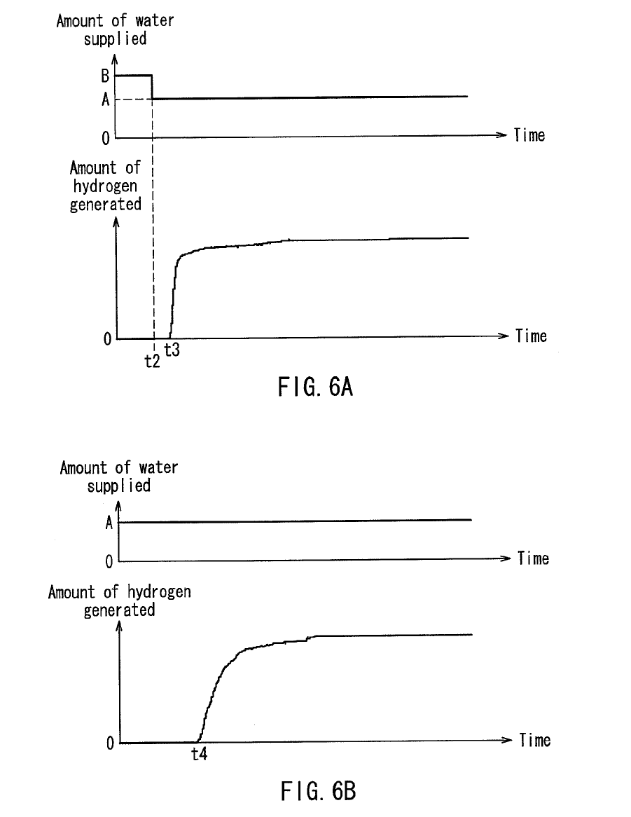

Next, FIGS. 5 and 6 show the relationship between the amount of water supplied and the amount of hydrogen generated when the water supply control is performed in the manner as shown in FIG. 4. The horizontal axis of each of the graphs in FIGS. 5 and 6 indicates the elapsed time from a point (t=0) at which the instructions to start the production of electric power are given.

FIG. 5 shows the relationship between the amount of water supplied and the amount of hydrogen generated when the cumulative amount of the water supplied to the container 3 (hydrogen generating portion) is less than the predetermined specific value, i.e., the reaction of the hydrogen generating material and the water has not proceeded much.

In this case, the predetermined amount of water supply A is supplied from the time “t=0”. Thus, hydrogen starts to be generated at the time t1. The amount of water supply A is appropriate for the case where the reaction of the hydrogen generating material and the water has not proceeded much. Therefore, the amount of hydrogen generated rises to a steady-state level immediately after the start of hydrogen generation, as shown in FIG. 5.

FIG. 6 shows the relationship between the amount of water supplied and the amount of hydrogen generated when the cumulative amount of the water supplied to the container 3 is not less than the predetermined specific value, i.e., the reaction of the hydrogen generating material and the water has proceeded at least to some extent.

FIG. 6A shows the fuel cell system of this embodiment. Since the reaction of the hydrogen generating material and the water has proceeded considerably, the amount of water supply B, which is larger than the amount of water supply A, is supplied from the start of the water supply to the time t2. In this manner, even if the start of the hydrogen generation reaction is slow particularly at the beginning of the hydrogen generation while the reaction of the hydrogen generating material and the water proceeds, hydrogen starts to be generated as early as at the time t3. Moreover, similarly to FIG. 5, the time it takes for the amount of hydrogen generated to reach a steady-state level, i.e., a so-called rise time is short.

However, as shown in FIG. 6B, when only the amount of water supply A, which is appropriate for the case where the reaction of the hydrogen generating material and the water has not yet proceeded (as shown in FIG. 5), is supplied regardless of the amount of the water supplied to the hydrogen generating portion, the start time t4 of the hydrogen generation is delayed. Even after that, the amount of hydrogen generated does not easily reach a predetermined value, and a so-called rise time is significantly long.

As described above, in the hydrogen generator 300 of this embodiment, it is possible to know the amount of the water supplied to the hydrogen generating material contained in the container that is frequently attached and detached with the fuel cartridge 17. Thus, the hydrogen generator 300 can easily and quickly generate hydrogen.

The method for generating hydrogen by supplying water to the hydrogen generating material, as disclosed in the present invention, has the following problems. When the same amount of water is supplied, the rise time from the start of the water supply to the generation of hydrogen varies depending on the history of how much the hydrogen generating material has reacted with water. Moreover, when the amount of the hydrogen generating material that has already reacted with the water exceeds a certain ratio, in some cases, hydrogen will not continue to be stably generated even if unreacted hydrogen generating material still remains. However, by performing the water supply control in the hydrogen generator 300 of this embodiment, as shown in FIG. 4, the above problem with the amount of the hydrogen generating material that has already reacted with the water can be solved, and the hydrogen generator can quickly and stably generate hydrogen for a long time. Thus, the production of electric power in the fuel cell starts early. Moreover, since an appropriate amount of water is supplied in accordance with the state of the hydrogen generating material, the hydrogen generating material is effectively used, and the fuel cell system can produce electric power for a long time.

In the above description of this embodiment, when the cumulative amount of the water supplied to the hydrogen generating material is larger than the predetermined specific value, the amount of water supply B, which is appropriate for the case where the reaction of the hydrogen generating material and the water proceeds, is supplied in the early stages of the hydrogen generation. However, the water supply control in the fuel cell of the present invention is not limited thereto. For example, even after the amount of water to be supplied to the hydrogen generating material in the beginning is optimized based on the cumulative amount of the water supplied to the hydrogen generating material, the water supply can be slightly increased until hydrogen is stably generated in accordance with the characteristics of the reaction of the water and the hydrogen generating material. Thus, the present invention allows the control portion 11 to control the amount of water to be supplied appropriately so as to achieve the optimum hydrogen generation conditions.

In the above description of this embodiment, the memory 18 stores the cumulative amount of the water supplied to the container 3 holding the hydrogen generating material. However, the information stored in the memory 18 of this embodiment is not limited to the cumulative amount of the water supplied, but may be the remaining amount of hydrogen that can be generated from the hydrogen generating material in the container 3, as described in Embodiment 1.

In the above description of this embodiment, the control portion has the function of controlling the water supply means so as to supply water in the most suitable amount and at the most suitable supply rate in accordance with the amount of hydrogen that can be generated from the hydrogen generating material in the container (hydrogen generating portion). Needless to say, this function also can be applied to the hydrogen generator in Embodiment 1, in which the hydrogen generating portion is not included in the fuel cartridge.

As described above, the fuel cell system of this embodiment changes the conditions of the water supply to the hydrogen generating material based on the cumulative amount of the water supplied to the hydrogen generating material that is read from the memory in the fuel cartridge. Therefore, in the case of a fuel cartridge with a large cumulative amount of water supplied, it is possible to reduce the time required for the start of hydrogen generation. In the case of a fuel cartridge with a small cumulative amount of water supplied, it is possible to prevent the occurrence of an excessive hydrogen generation reaction due to a larger amount of water supply than necessary

Each of the above embodiments of the present invention describes the hydrogen generator and the fuel cell system including the fuel cell that uses the hydrogen generated by the hydrogen generator as a fuel. However, the hydrogen generator of the present invention is not limited to generating hydrogen as a fuel for the fuel cell. The hydrogen generator of the present invention can be generally utilized as a hydrogen generator for generating hydrogen that is used for various equipment, e.g., hydrogen that is stored in a hydrogen-storing alloy.

### INDUSTRIAL APPLICABILITY

As described above, the hydrogen generator of the present invention has wide industrial applicability as a hydrogen generator capable of calculating the remaining amount of hydrogen that can be generated. Moreover, the fuel cell system that includes this hydrogen generator and the fuel cell using hydrogen as a fuel is widely applicable to various power sources such as a power source for small portable equipment.

1. A hydrogen generator comprising:
a hydrogen generating portion that holds a hydrogen generating material that reacts with water to generate hydrogen;
a water supply means that supplies the water to the hydrogen generating portion;
a water supply control means that controls the water supply means so as to adjust an amount of the water to be supplied to the hydrogen generating portion; and
a remaining amount management means that estimates a remaining amount of hydrogen that can be generated in the hydrogen generating portion from water quantity information of the water supplied to the hydrogen generating portion, the water quantity information being obtained from the water supply means or the water supply control means.

2. The hydrogen generator according to claim 1, wherein the remaining amount management means estimates the remaining amount of hydrogen that can be generated in the hydrogen generating portion from a total amount of the water supplied to the hydrogen generating portion.

3. The hydrogen generator according to claim 1, wherein the remaining amount management means estimates the remaining amount of hydrogen that can be generated in the hydrogen generating portion from an operation time of the water supply means.

4. The hydrogen generator according to claim 1, the water supply means is electrically powered, and the remaining amount management means estimates the remaining amount of hydrogen that can be generated in the hydrogen generating portion from a cumulative value of a voltage applied to the water supply means.

5. The hydrogen generator according to claim 1, wherein an attachable/detachable fuel cartridge holding the hydrogen generating material is provided as the hydrogen generating portion, and
the fuel cartridge comprises a memory for storing the amount of the water supplied or the remaining amount of hydrogen that can be generated.

6. The hydrogen generator according to claim 1, wherein the water supply control means controls the amount of the water to be supplied by the water supply means based on the water quantity information of the water supplied to the hydrogen generating portion.

7. A fuel cell system comprising:
the hydrogen generator according to claim 1; and
a fuel cell that produces electric power using the hydrogen generated by the hydrogen generator.
